(19) United States
(12) Patent Application Publication
(10) Pub. No.: US 2026/0286940 A1
(43) Pub. Date: Sep. 24, 2026

(54) PRESSURE AND TEMPERATURE RECOVERY SYSTEMS FOR GEOTHERMAL POWER PLANTS

(71) Applicant: Sage Geosystems Inc., Houston, TX (US)

(72) Inventors: Robert Lance COOK, Houston, TX (US); Douglas SIMPKINS, Houston, TX (US); Lev M. RING, Bellaire, TX (US); Michael HILL, The Woodlands, TX (US); Nathan WEISS, Bellaire, TX (US)

(21) Appl. No.: 19/474,014

(22) PCT Filed: Apr. 19, 2024
(86) PCT No.: PCT/US2024/025455

§ 371 Date: Oct. 9, 2025

Related U.S. Application Data
(60) Provisional application No. 63/497,661, filed on Apr. 21, 2023.
(60) Provisional application No. 63/499,883, filed on May 3, 2023.

(51) Int. Cl. F03G 4/00

(52) U.S. Cl. CPC F03G 4/001; F03G 4/026

(57) ABSTRACT

A geothermal power system includes a pressure exchanger fluidically coupled to a heat exchanger. A first fluid enters the pressure exchanger at a first inlet, and flows in a first fluid path to a first outlet. The first fluid flows from the first outlet to the heat exchanger. The first fluid heats a second fluid at the heat exchanger. The first fluid flows from the heat exchanger to a second inlet of the pressure exchanger. The first fluid enters the pressure exchanger at the second inlet, and flows in a second fluid path to a second outlet. A pressure of the first fluid reduces as the first fluid transits through the pressure exchanger along the first fluid path. A pressure of the first fluid increases as the first fluid transits through the pressure exchanger along the second fluid path.

### CROSS-REFERENCE TO RELATED APPLICATIONS

This application is an International Patent Application under the Patent Cooperation Treaty and claims priority to and the benefit of: U.S. Provisional Patent Application Ser. No. 63/497,661 filed Apr. 21, 2023, titled Pressure and Temperature Recovery Systems for Geothermal Power Plants; and U.S. Provisional Patent Application Ser. No. 63/499,883 filed May 3, 2023, titled Geothermal and Geopressure Recovery Systems. The disclosures of each of U.S. Provisional Patent Application Ser. No. 63/497,661 and U.S. Provisional Patent Application Ser. No. 63/499,883 are incorporated herein in their entireties by this reference.

### BACKGROUND

### Field

Embodiments of the present disclosure generally relate to geothermal power systems and processes, and particularly to the recovery of geothermal heat energy and pressure energy to perform useful work, such as generating electricity.

### Description of the Related Art

Geothermal energy is a type of renewable energy generated within the earth. A geothermal fluid (such as water, steam, brine, or hydrocarbons) is heated in a subterranean geological formation by the earth's natural internal temperature. The heated geothermal fluid is produced to the earth's surface. The enthalpy of the geothermal fluid includes a heat energy component and a pressure-volume energy component. Typically, the heat energy component is greater than the pressure-volume energy component. At the earth's surface, the heat energy component is used to perform useful work, such as heating buildings or generating electricity in a geothermal power system. However, the pressure-volume energy component is usually wasted, such as by venting. After performing useful work, the geothermal fluid is reinjected into the subterranean formation, reheated by the subterranean formation, then produced again to the earth's surface to perform useful work.

Some geothermal power systems generate electricity by using the geothermal fluid to drive a steam turbine. However, where the produced geothermal fluid is at or below about 180 degrees C., geothermal power systems typically incorporate a binary cycle power plant to generate electricity. A heat exchanger of the binary cycle power plant transfers heat, but not pressure, from the geothermal fluid to a working fluid of the binary cycle power plant.

In an example, operation of the binary cycle power plant is based on the Brayton Cycle, in which the heated working fluid passes through a turbine, which drives a generator. In another example, operation of the binary cycle power plant is based on the Organic Rankine Cycle, in which the heated working fluid passes through an expander, which drives a generator. Typically, binary cycle power plants utilize only the heat energy component of the enthalpy of the geothermal fluid. The pressure-volume energy component is wasted, such as by venting.

The efficiency of a geothermal power system depends on the amount of energy (in the form of heat energy and pressure-volume energy) that can be transferred from the subterranean geological formation to the geothermal fluid, and depends on the proportion of that energy that is converted into useful work. Typically, the efficiency of converting geothermal energy (in the form of heat energy plus pressure-volume energy) into electricity is less than 15 percent.

Thus, there is a need for improved systems and processes that facilitate the conversion of geothermal energy into electricity.

### SUMMARY

The present disclosure generally relates to geothermal power systems and processes, and particularly to the recovery of geothermal heat energy and pressure energy to perform useful work, such as generating electricity. In one implementation, a method of operating a geothermal power system includes flowing a first fluid into a first inlet of a first pressure exchanger, and flowing the first fluid from a first outlet of the first pressure exchanger to a heat exchanger. The method further includes flowing the first fluid from the heat exchanger to a second inlet of the first pressure exchanger, and discharging the first fluid from a second outlet of the first pressure exchanger.

In another implementation, a method of operating a geothermal power system includes flowing a first fluid into a first inlet of a pressure exchanger, and reducing a pressure of the first fluid in the pressure exchanger as the first fluid transits from the first inlet of the pressure exchanger to a first outlet of the pressure exchanger. The method further includes increasing a pressure of a second fluid in the pressure exchanger as the second fluid transits from a second inlet of the pressure exchanger to a second outlet of the pressure exchanger. The second fluid has a first temperature at the second outlet. The method further includes flowing the second fluid through a turbine coupled to a generator. The second fluid enters the turbine at a second temperature substantially equal to the first temperature. The method further includes generating electricity using the generator. The method further includes flowing the second fluid from the turbine to the second inlet of the pressure exchanger. The second fluid exits the turbine at a third temperature, and enters the second inlet of the pressure exchanger at a fourth temperature substantially equal to the third temperature.

In another implementation, a geothermal power system includes a heat exchanger fluidically coupled to a first pressure exchanger. The first pressure exchanger is configured such that a first fluid enters the first pressure exchanger at a first inlet, and transits through the first pressure exchanger in a first fluid path from the first inlet to a first outlet. The heat exchanger receives the first fluid from the first outlet of the first pressure exchanger, and the first pressure exchanger receives the first fluid from the heat exchanger at a second inlet of the pressure exchanger. The first pressure exchanger is further configured such that the first fluid transits through the first pressure exchanger in a second fluid path from the second inlet to a second outlet. The second fluid path is separate from the first fluid path.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1A schematically illustrates a geothermal power system.

FIG. 1B schematically illustrates a manifold assembly that may be incorporated into the geothermal power system of FIG. 1A.

FIG. 2A schematically illustrates a geothermal power system.

FIG. 2B schematically illustrates process flows for a single well that may be used with the geothermal power system of FIG. 2A.

FIG. 3A schematically illustrates a geothermal power system.

FIG. 3B schematically illustrates a flowline assembly that may be used with the geothermal power system of FIG. 3A.

FIG. 4 schematically illustrates a geothermal power system.

FIG. 5 is a flow diagram of a method of operating a geothermal power system.

FIG. 6 is a flow diagram of a method of operating a geothermal power system.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure concerns geothermal power systems and processes, and particularly to the recovery of geothermal energy to perform useful work, such as generating electricity.

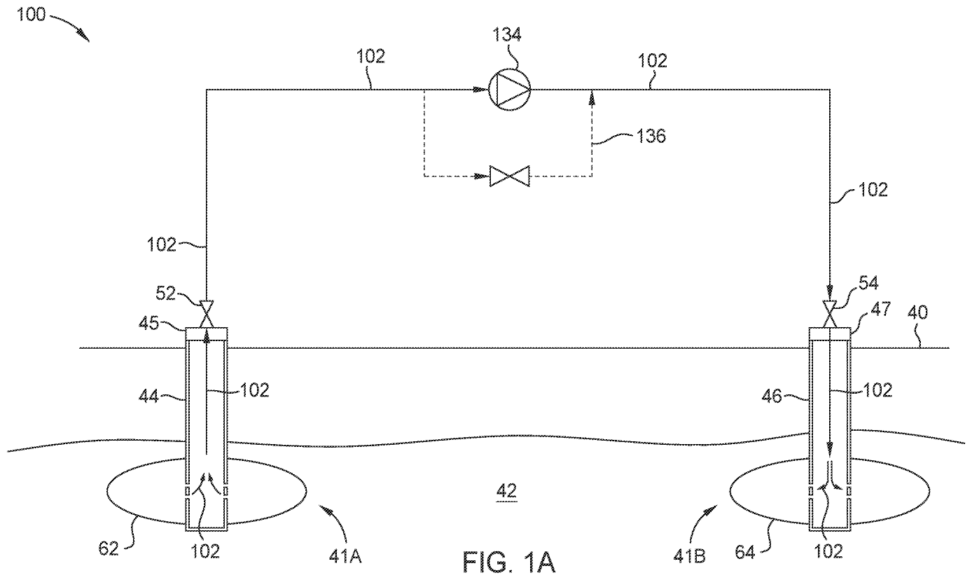

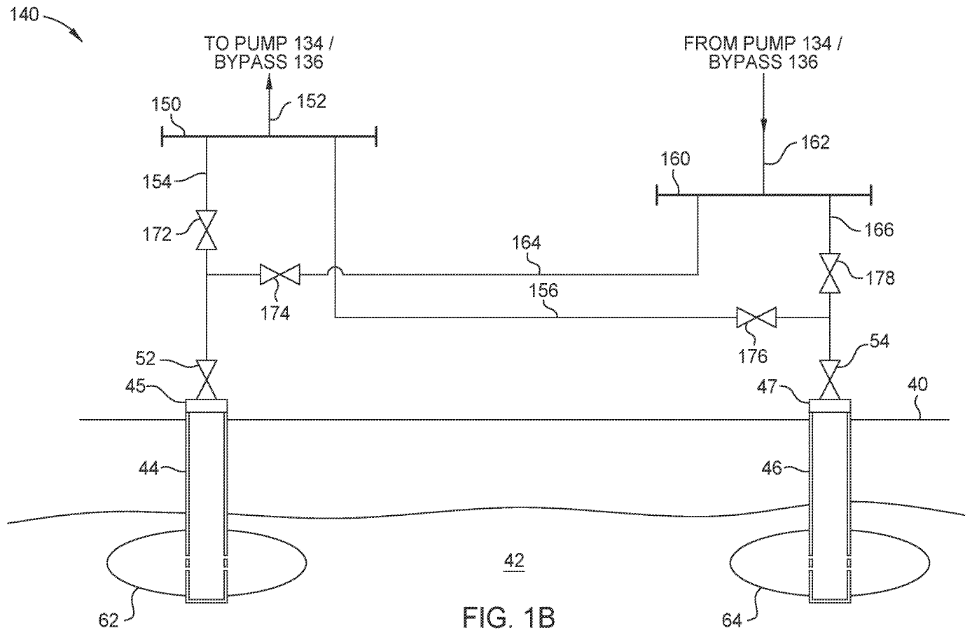

FIG. 1A schematically illustrates a geothermal power system 100. The geothermal power system 100 is configured to transfer a geothermal fluid (represented by arrows 102) between a first subterranean location 41A and a second subterranean location 41B. The first subterranean location 41A is fluidically coupled to a first well 44, such as via one or more fractures 62. The second subterranean location 41B is fluidically coupled to a second well 46, such as via one or more fractures 64.

A wellhead 45 of the first well 44 is fluidically coupled to one or more pumps 134. A valve 52 (such as a choke or control valve) at the wellhead 45 can be adjusted to control a flow of fluid between the first well 44 and the one or more pumps 134. A wellhead 47 of the second well 46 is fluidically coupled to the one or more pumps 134. A valve 54 (such as a choke or control valve) at the wellhead 47 can be adjusted to control a flow of fluid between the second well 46 and the one or more pumps 134.

As illustrated, in some embodiments, the first subterranean location 41A and the second subterranean location 41B are in a subterranean formation 42 below the earth's surface 40. In other embodiments, the first subterranean location 41A is in a first subterranean formation, and the second subterranean location 41B is in a second subterranean formation that is different from the first subterranean formation. In an example, the second subterranean formation may be separated from the first subterranean formation by other geological layers such that one of the first or the second subterranean formations is at a relatively shallow depth below the earth's surface 40 compared with a depth of the other of the first or the second subterranean formations.

In some embodiments, the first subterranean location 41A and the second subterranean location 41B are at different depths below the earth's surface 40 despite being in the same subterranean formation 42.

The geothermal fluid 102 may include any fluid (such as water, steam, brine, a refrigerant, a supercritical fluid, carbon dioxide, ammonia, an organic compound, or any combination thereof) that is injected into, or produced out of, the subterranean formation 42. In some embodiments, the geothermal fluid 102 includes suspended solids. In an example, the geothermal fluid 102 has a solids content of 0.5% by volume or greater, such as up to 1% by volume, up to 3% by volume, or up to 5% by volume In some embodiments, the geothermal fluid 102 is filtered to remove at least a portion of the suspended solids. For example, the geothermal fluid 102 may be filtered (such as by a screen) in the first well 44, at the wellhead 45, or between the wellhead 45 and the one or more pumps 134. In some embodiments, the subterranean formation 42 is a geothermal subterranean formation.

The geothermal fluid 102 is heated, or is maintained at an elevated temperature, by the subterranean formation 42. In an example, the temperature of the geothermal fluid 102 is at or about 150 degrees C. or higher, such as 175 degrees C. or higher, 200 degrees C. or higher, 250 degrees C. or higher, or 300 degrees C. or higher. The geothermal fluid 102 is maintained at an elevated pressure in the subterranean formation 42. In an example, the pressure of the geothermal fluid 102 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the geothermal fluid 102 is geopressured. In an example, the geothermal fluid 102 may be a geopressured-geothermal fluid.

The geothermal fluid 102 flows from the subterranean formation 42 at the first subterranean location 41A into the first well 44. In some embodiments, the geothermal fluid 102 flows from the subterranean formation 42 into the first well 44 via the one or more fractures 62 in the subterranean formation 42 at the first well 44.

The geothermal fluid 102 flows from the first well 44 to the one or more pumps 134. Exemplary pumps 134 include single phase pumps, multi-phase pumps, centrifugal pumps, positive displacement pumps, or the like. The one or more pumps 134 increase a pressure of the geothermal fluid 102, and inject the geothermal fluid 102 into the second well 46. In some embodiments, the one or more pumps 134 are booster pumps. In an example, the pressure increase provided by the one or more pumps 134 is less than an inlet pressure of the one or more pumps 134. In some embodiments, the one or more pumps 134 are operated at an efficiency of 90% or above, such as 92% or above, or 95% or above.

The geothermal fluid 102 flows from the second well 46 into the subterranean formation 42 at the second subterranean location 41B. In some embodiments, the geothermal fluid 102 flows from the second well 46 into the subterranean formation 42 via the one or more fractures 64 in the subterranean formation 42.

In some embodiments, at the commencement of flowing the geothermal fluid 102 from the first well 44, a pressure of the geothermal fluid 102 at the wellhead 45 of the first well 44 is greater than a pressure of the geothermal fluid 102 at the wellhead 47 of the second well 46. In some of such embodiments, the geothermal fluid 102 flows through a bypass 136 of the one or more pumps 134 when flowing from the first well 44 to the second well 46. As flow of the geothermal fluid 102 continues, the pressure of the geothermal fluid 102 at the wellhead 45 of the first well 44 decreases, and the pressure of the geothermal fluid 102 at the wellhead 47 of the second well 46 increases. The pressure of the geothermal fluid 102 at the wellhead 45 of the first well 44 and the pressure of the geothermal fluid 102 at the wellhead 47 of the second well 46 approach an equilibrium. Prior to, or upon, the pressure at the wellhead 45 and the pressure at the wellhead 47 reaching an equilibrium, the flow of the geothermal fluid 102 is routed to the one or more pumps 134, which pump the geothermal fluid 102 into the second well 46. In some embodiments, continuing operation of the one or more pumps 134 causes the pressure of the geothermal fluid 102 at the wellhead 47 of the second well 46 to increase beyond the pressure of the geothermal fluid 102 at the wellhead 45 of the first well 44.

In some embodiments, the pressure of the geothermal fluid 102 at the wellhead 45 of the first well 44 is maintained at a magnitude such that the one or more fractures 62 remain open while the one or more pumps 134 pump the geothermal fluid 102 into the second well 46. In an example, the flow of the geothermal fluid 102 out of the first well 44 is choked by the valve 52. In some embodiments, the pressure of the geothermal fluid 102 at the wellhead 47 of the second well 46 is maintained (such as by operation of the one or more pumps 134) at a magnitude such that the one or more fractures 64 remain open.

In some embodiments, the geothermal fluid 102 does not flow within the subterranean formation 42 from the second well 46 to the first well 44. In an example, the one or more fractures 62 do not intersect with the one or more fractures 64. In another example, the one or more fractures 62 are not contiguous with the one or more fractures 64. In some of such embodiments, the geothermal power system 100 is reconfigured to transfer the geothermal fluid 102 from the second subterranean location 41B to the first subterranean location 41A by producing the geothermal fluid 102 from the second well 46, and injecting the geothermal fluid 102 into the first well 44.

FIG. 1B schematically illustrates an example manifold assembly 140 that facilitates reconfiguring the geothermal power system 100 to flow the geothermal fluid 102 from the second well 46 to the one or more pumps 134 (or the bypass 136), and to flow the returning geothermal fluid 102 from the one or more pumps 134 (or the bypass 136) to the first well 44. In some embodiments, geothermal power system 100 incorporates the manifold assembly 140.

The manifold assembly 140 includes a production manifold 150 and an injection manifold 160. Line 152 conveys the geothermal fluid 102 from the production manifold 150 to the one or more pumps 134 (or the bypass 136). Line 162 conveys the geothermal fluid 102 from the one or more pumps 134 (or the bypass 136) to the injection manifold 160. Line 154 conveys the geothermal fluid 102 from the first well 44 to the production manifold 150. Line 164 conveys the geothermal fluid 102 from the injection manifold 160 to the first well 44. When geothermal fluid 102 is flowing from the first well 44 to the production manifold 150, valve 172 in line 154 is open, and valve 174 in line 164 is closed. When geothermal fluid 102 is flowing from the injection manifold 160 to the first well 44, valve 174 in line 164 is open, and valve 172 in line 154 is closed.

Line 156 conveys the geothermal fluid 102 from the second well 46 to the production manifold 150. Line 166 conveys the geothermal fluid 102 from the injection manifold 160 to the second well 46. When geothermal fluid 102 is flowing from the second well 46 to the production manifold 150, valve 176 in line 156 is open, and valve 178 in line 166 is closed. When geothermal fluid 102 is flowing from the injection manifold 160 to the second well 46, valve 178 in line 166 is open, and valve 176 in line 156 is closed.

In some embodiments, reconfiguring the geothermal power system 100 is prompted by a trigger condition. In an example, the trigger condition includes the flow of geothermal fluid 102 from the first well 44 to the one or more pumps 134 (or the bypass 136) diminishing to or beyond a threshold level. In another example, the trigger condition includes the pressure of geothermal fluid 102 at the wellhead 45 of the first well 44 diminishing to or beyond a threshold level. In another example, the trigger condition includes the flow of geothermal fluid 102 into the second well 46 diminishing to or beyond a threshold level. In another example, the trigger condition includes the pressure of geothermal fluid 102 at the wellhead 47 of the second well 46 rising to or beyond a threshold level.

When reconfiguring the geothermal power system 100 to flow the geothermal fluid 102 from the second subterranean location 41B to the first subterranean location 41A, the first well 44 is closed-in, such as by closing the valve 52. In some embodiments, the second well 46 is closed-in, such as by closing valve 54. The manifold assembly 140 is operated such that valve 172 is closed, valve 174 is opened, valve 176 is opened, and valve 178 is closed. Valve 52 is opened to allow geothermal fluid 102 to be injected into the first well 44. If the second well 46 is closed-in, valve 54 is opened to allow geothermal fluid 102 to be produced from the second well 46. The geothermal fluid 102 flows from the subterranean formation 42 via the second well 46 to the one or more pumps 134 (or the bypass 136), as described above. The returning geothermal fluid 102 flows into the subterranean formation 42 via the first well 44, as described above.

In some embodiments, more than two wells are coupled to the production manifold 150 and to the injection manifold 160. In an example, production of geothermal fluid 102 is started from a third well while the second well 46 remains closed-in. The geothermal fluid 102 flows to the geothermal power system 100 as described above. The geothermal fluid 102 may then be injected into the first well 44 or into a fourth well.

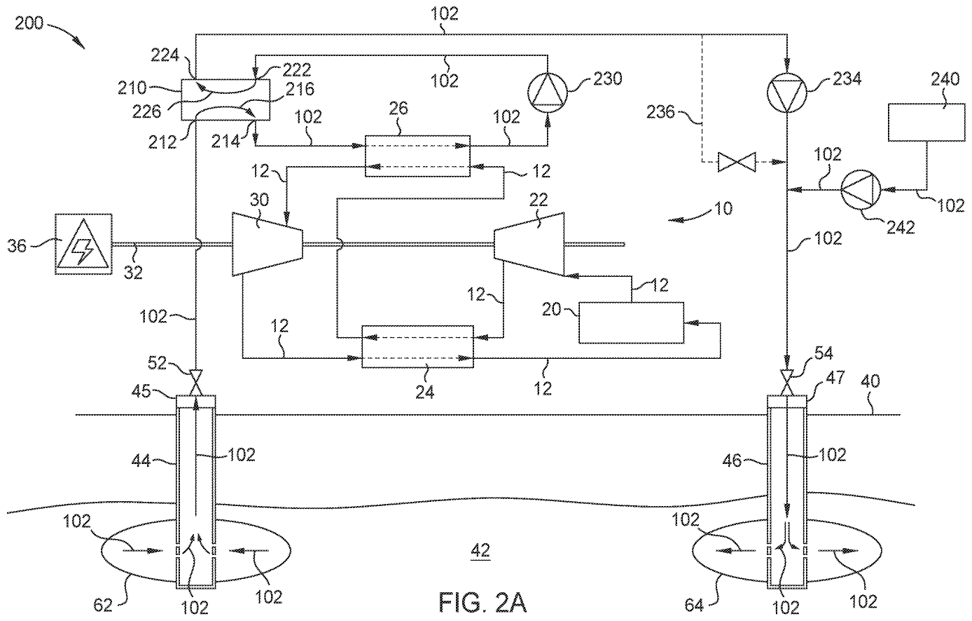

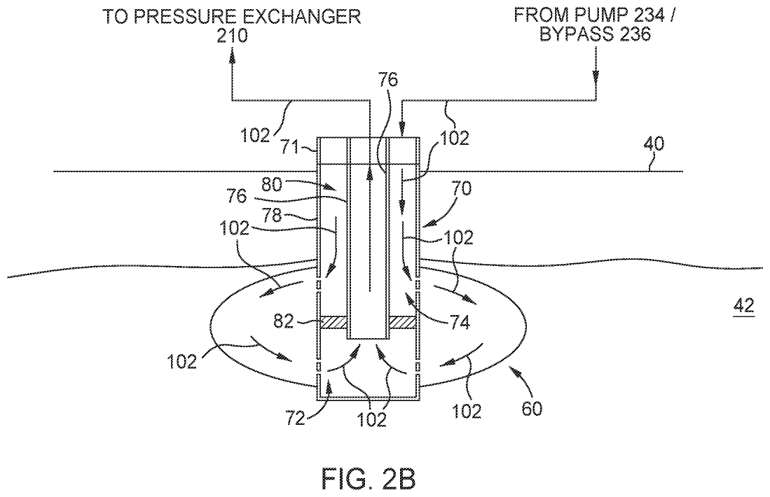

FIG. 2A schematically illustrates a geothermal power system 200. The geothermal power system 200 includes a binary cycle power plant 10. In some embodiments, operation of the binary cycle power plant 10 is based on the Brayton Cycle. In some embodiments, operation of the binary cycle power plant 10 is based on the Rankine Cycle. In some embodiments, operation of the binary cycle power plant 10 is based on the Organic Rankine Cycle.

The binary cycle power plant 10 utilizes a working fluid (represented by arrows 12), such as water, steam, brine, a refrigerant, a supercritical fluid, carbon dioxide, ammonia, an organic compound (e.g., a hydrocarbon, a fluorocarbon, etc.), or any combination thereof. The working fluid 12 flows from a condenser 20 to a pressure booster 22, such as a pump (e.g. a single phase pump, a multi-phase pump, a centrifugal pump, or a positive displacement pump), a compressor, or the like. The pressure booster 22 increases the pressure of the working fluid 12, and moves the working fluid 12 through a recuperator 24 to a heat exchanger 26, where the working fluid 12 is heated. Exemplary types of heat exchanger 26 include concurrent flow, counter-flow, shell and tube, paraflow plate, and the like.

The heated working fluid 12 then flows to an expander 30, such as a turbine, a turbo-expander, or the like. The working fluid 12 drives the expander 30 to rotate a shaft 32. The shaft 32 is coupled to a generator 36. In an example, the shaft 32 is coupled to the generator 36 via a gearbox. The shaft 32 drives the generator 36 to produce electricity. The working fluid 12 loses pressure in driving the expander 30, and a temperature of the working fluid 12 drops. The working fluid 12 exits the expander 30, and passes through the recuperator 24, and back to the condenser 20.

In some embodiments, the pressure booster 22 and the expander 30 are coupled to a common shaft, such as shaft 32. In some embodiments, the pressure booster 22, the expander 30, and the generator 36 are coupled to a common shaft, such as shaft 32.

The geothermal power system 200 utilizes the geothermal fluid 102 described above. In some embodiments, the working fluid 12 in the binary cycle power plant 10 is segregated from the geothermal fluid 102. In some embodiments, the working fluid 12 may include at least a portion of the geothermal fluid 102. In some embodiments, the geothermal fluid 102 may include at least a portion of the working fluid 12.

The geothermal fluid 102 is heated, or is maintained at an elevated temperature, by the subterranean formation 42. In an example, the temperature of the geothermal fluid 102 is at or about 150 degrees C. or higher, such as 175 degrees C. or higher, 200 degrees C. or higher, 250 degrees C. or higher, or 300 degrees C. or higher. The geothermal fluid 102 is maintained at an elevated pressure in the subterranean formation 42. In an example, the pressure of the geothermal fluid 102 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the geothermal fluid 102 is geopressured. In an example, the geothermal fluid 102 may be a geopressured-geothermal fluid.

The geothermal fluid 102 flows from the subterranean formation 42 into a first well 44. In some embodiments, the geothermal fluid 102 flows from the subterranean formation 42 into the first well 44 via one or more fractures 62 in the subterranean formation 42 at the first well 44. In some embodiments, the temperature of the geothermal fluid 102 at the wellhead 45 of the first well 44 is at or near the temperature of the geothermal fluid 102 in the subterranean formation 42.

The geothermal fluid 102 flows from the first well 44 to a pressure exchanger 210. The pressure exchanger 210 may be of any type or combination, such as disclosed in any of Azam Thatte, A New Type of Rotary Liquid Piston Pump for Multi-Phase CO2 Compression, Proceedings of ASME Turbo Expo 2018, GT2018-77011 (Jun. 11-15, 2018, Oslo, Norway); U.S. Pat. No. 5,988,993 titled Pressure Exchanger Having a Rotor With Automatic Axial Alignment, that issued Nov. 23, 1999; or U.S. Pat. No. 10,731,702 titled System and Method for Hybrid Hydrodynamic-Hydrostatic Thrust Bearings, that issued Aug. 4, 2020; all of which are incorporated herein by reference. In some embodiments, the geothermal power system 200 includes a plurality of pressure exchangers 210, such as in a parallel hookup configuration.

The geothermal fluid 102 flows into the pressure exchanger 210 at a first inlet 212, and exits the pressure exchanger 210 at a first outlet 214. The pressure of the geothermal fluid 102 is reduced as the geothermal fluid 102 transits through the pressure exchanger 210 from the first inlet 212 to the first outlet 214 along a first fluid path 216. In an example, the pressure of the geothermal fluid 102 at the first outlet 214 is at or about 20 MPa or less, such as 15 MPa or less, 10 MPa or less, 5 MPa or less, 3 MPa or less, 1 MPa or less, 0.5 MPa or less, or 0.2 MPa or less. The temperature of the geothermal fluid 102 at the first inlet 212 is at or near the temperature of the geothermal fluid 102 at the wellhead 45 of the first well 44. The temperature of the geothermal fluid 102 at the first outlet 214 is at or near the temperature of the geothermal fluid 102 at the first inlet 212.

The geothermal fluid 102 flows from the first outlet 214 of the pressure exchanger 210 to the heat exchanger 26. In some embodiments, the temperature of the geothermal fluid 102 entering the heat exchanger 26 is similar to the temperature of the geothermal fluid 102 at the first well 44. In an example, the geothermal fluid 102 is at or about 150 degrees C. or higher, such as 175 degrees C. or higher, 200 degrees C. or higher, 250 degrees C. or higher, or 300 degrees C. or higher when entering the heat exchanger. Heat is transferred from the geothermal fluid 102 to the working fluid 12 as the geothermal fluid 102 flows through the heat exchanger 26. The temperature of the geothermal fluid 102 is lowered to a reduced level as the geothermal fluid 102 flows through the heat exchanger 26. In an example, the temperature of the geothermal fluid 102 upon exiting the heat exchanger 26 is at or about 100 degrees C. or less, such as 90 degrees C. or less, 80 degrees C. or less, 70 degrees C. or less, 60 degrees C. or less, or 50 degrees C. or less.

In some embodiments, the geothermal fluid 102 flows from the heat exchanger 26 to one or more pumps 230. Exemplary pumps 230 include single phase pumps, multi-phase pumps, centrifugal pumps, positive displacement pumps, or the like. In some embodiments, the geothermal fluid 102 flows from the heat exchanger 26 to an intermediate reservoir (such as a pond, a tank, or a subterranean formation different from subterranean formation 42), before flowing to the one or more pumps 230. In some embodiments, the intermediate reservoir is omitted. In some embodiments, the one or more pumps 230 are omitted.

The geothermal fluid 102 flows from the heat exchanger 26 or the intermediate reservoir (if present) via the one or more pumps 230 (if present) to a second inlet 222 of the pressure exchanger 210. In some embodiments, the intermediate reservoir functions as a buffer to facilitate controlling the flow rate of the geothermal fluid 102 from the heat exchanger 26 to the second inlet 222 of the pressure exchanger 210. In an example, the flow rate of the geothermal fluid 102 from the heat exchanger 26 to the second inlet 222 of the pressure exchanger 210 is controlled to smooth out spikes and dips. In another example, the flow rate of the geothermal fluid 102 from the heat exchanger 26 to the second inlet 222 of the pressure exchanger 210 is controlled to correspond to the flow rate of the geothermal fluid 102 from the first outlet 214 of the pressure exchanger 210 to the heat exchanger 26.

The geothermal fluid 102 flows into the pressure exchanger 210 at the second inlet 222, and exits the pressure exchanger 210 at a second outlet 224. The pressure exchanger 210 utilizes the pressure of the relatively hotter geothermal fluid 102 at the first inlet 212 to increase the pressure of the relatively colder geothermal fluid 102 that enters the pressure exchanger 210 at the second inlet 222. The pressure of the geothermal fluid 102 is increased as the geothermal fluid 102 transits through the pressure exchanger 210 from the second inlet 222 to the second outlet 224 along a second fluid path 226. The second fluid path 226 is separate from the first fluid path 216. In an example, the pressure of the geothermal fluid 102 at the second outlet 224 is at or about 3 MPa or higher, such as 5 MPa or higher, 10 MPa or higher, 20 MPa or higher, 30 MPa or higher, 40 MPa or higher, or 50 MPa or higher. In some embodiments, the pressure of the geothermal fluid 102 at the second outlet 224 is less than the pressure of the geothermal fluid 102 at the first inlet 212. The temperature of the geothermal fluid 102 remains at or near the reduced level as the geothermal fluid 102 transits through the pressure exchanger 210 from the second inlet 222 to the second outlet 224 along the second fluid path 226.

The circuit of routing the geothermal fluid 102 through the pressure exchanger 210, then through the heat exchanger 26, then back through the pressure exchanger 210 provides several benefits. For example, the heat exchanger 26 may be designed to operate at pressures that are lower than the pressure of the geothermal fluid 102 at the wellhead 45, which avoids the expense and inefficiencies of so-called “high pressure heat exchangers” configured to operate at pressures higher than conventional heat exchangers. Additionally, the pressure of the geothermal fluid 102 itself exiting the first well 44 is used to boost the pressure of the geothermal fluid 102 exiting the heat exchanger 26, which avoids the expense and inefficiencies of pumps that operate at pressure ratios (outlet pressure divided by inlet pressure) of ten or more. The pressure of the geothermal fluid 102 at the wellhead 45 is usefully employed, rather than being wasted.

In some embodiments, the geothermal fluid 102 flows from the pressure exchanger 210 to one or more pumps 234. Exemplary pumps 234 include single phase pumps, multi-phase pumps, centrifugal pumps, positive displacement pumps, or the like. The one or more pumps 234 increase a pressure of the geothermal fluid 102, and inject the geothermal fluid 102 into the second well 46. In some embodiments, the one or more pumps 234 are booster pumps. In an example, the pressure increase provided by the one or more pumps 234 is less than an inlet pressure of the one or more pumps 234. In some embodiments, the one or more pumps 234 are operated at an efficiency of 90% or above, such as 92% or above, or 95% or above.

In some embodiments, the pressure of the geothermal fluid 102 at the second outlet 224 of the pressure exchanger 210 is greater than the pressure of the geothermal fluid 102 at the wellhead 47 of the second well 46. In some of such embodiments, the geothermal fluid 102 flows through a bypass 236 of the one or more pumps 234 when flowing from the pressure exchanger 210 to the second well 46. As flow of the geothermal fluid 102 continues, the pressure at the wellhead 47 of the second well 46 increases. The pressure at the second outlet 224 of the pressure exchanger 210 and the pressure at the wellhead 47 of the second well 46 approach an equilibrium. Prior to, or upon, the pressures at the second outlet 224 of the pressure exchanger 210 and at the wellhead 47 reaching an equilibrium, the geothermal fluid 102 is routed to the one or more pumps 234, which pump the geothermal fluid 102 into the second well 46.

In some embodiments, additional geothermal fluid 102 is injected into the second well 46 from a reservoir 240 (such as a pond, a tank, or a subterranean formation different from subterranean formation 42), using one or more charge pumps 242. Exemplary charge pumps 242 include single phase pumps, multi-phase pumps, centrifugal pumps, positive displacement pumps, or the like. In some embodiments, the additional geothermal fluid 102 is a make-up fluid that compensates for losses of geothermal fluid 102 into the subterranean formation 42. In some embodiments, the one or more charge pumps 242 pump geothermal fluid 102 from the reservoir 240 into the second well 46 to establish a selected operating pressure at the wellhead 47 of the second well 46. The operating pressure at the wellhead 47 of the second well 46 may be selected such that the one or more fractures 64 in the subterranean formation 42 are open.

In some embodiments, the one or more charge pumps 242 are fluidically coupled to the wellhead 47 via the flowline from the one or more pumps 234 (or the bypass 236) to the wellhead 47. In some embodiments, the one or more charge pumps 242 are fluidically coupled directly to the wellhead 47 via a separate flowline.

In some embodiments, the one or more charge pumps 242 are operated intermittently to pump geothermal fluid 102 from the reservoir 240 and into the second well 46 while geothermal fluid 102 flows from the pressure exchanger 210 to the second well 46. In some embodiments, the one or more charge pumps 242 are operated continuously to pump geothermal fluid 102 from the reservoir 240 and into the second well 46 while geothermal fluid 102 flows from the pressure exchanger 210 to the second well 46. In some embodiments, the reservoir 240 and the one or more charge pumps 242 may be omitted.

In some embodiments, the pressure of the geothermal fluid 102 at the wellhead 45 of the first well 44 is maintained at a magnitude such that the one or more fractures 62 remain open while flowing the geothermal fluid 102 to the pressure exchanger 210. In an example, the flow of the geothermal fluid 102 out of the first well 44 is choked by the valve 52. In another example, the pressure exchanger 210 is operated such that a back-pressure is exerted on the geothermal fluid 102 at the wellhead 45 of the first well 44.

In some embodiments, the pressure of the geothermal fluid 102 at the wellhead 47 of the second well 46 is maintained at a magnitude such that the one or more fractures 64 remain open. In an example, the one or more pumps 234 are operated to maintain the pressure of the geothermal fluid 102 at the wellhead 47 of the second well 46 at a magnitude such that the one or more fractures 64 remain open. In another example, the pressure exchanger 210 is operated such that the pressure of the geothermal fluid 102 exiting the pressure exchanger 210 at the second outlet 224 is at a magnitude such that the pressure of the geothermal fluid 102 at the wellhead 47 of the second well 46 is sufficient to maintain the one or more fractures 64 open. In a further example, the one or more charge pumps 242 (if present) are operated such that the pressure of the geothermal fluid 102 at the wellhead 47 of the second well 46 is sufficient to maintain the one or more fractures 64 open.

In some embodiments, the one or more fractures 62 intersect with the one or more fractures 64. In some embodiments, the one or more fractures 62 are contiguous with the one or more fractures 64. In some embodiments, the geothermal fluid 102 flows within the subterranean formation 42 from the second well 46 to the first well 44, and is produced again from the first well 44.

As illustrated, in some embodiments, the geothermal fluid 102 does not flow within the subterranean formation 42 from the second well 46 to the first well 44. In an example, the one or more fractures 62 do not intersect with the one or more fractures 64. In another example, the one or more fractures 62 are not contiguous with the one or more fractures 64. In such embodiments, the geothermal power system 200 is reconfigured to flow the geothermal fluid 102 from the second well 46 to the pressure exchanger 210, and to flow the returning geothermal fluid 102 from the one or more pumps 234 to the first well 44. In an example, the geothermal power system 200 includes the manifold assembly 140, described above.

When the geothermal power system 200 includes the manifold assembly 140, line 152 fluidically couples the production manifold 150 with the pressure exchanger 210. When the geothermal power system 200 includes the manifold assembly 140, line 162 fluidically couples the one or more pumps 234 (or the bypass 236) to the injection manifold 160. In some embodiments, when the geothermal power system 200 includes the manifold assembly 140, line 162 fluidically couples the one or more charge pumps 242 to the injection manifold 160. In some embodiments, when the geothermal power system 200 includes the manifold assembly 140, an additional line fluidically couples the one or more charge pumps 242 to the injection manifold 160. The manifold assembly 140, first well 44, second well 46, third well (if present), and fourth well (if present) are operated as described above.

FIG. 2B schematically illustrates an embodiment in which well 70 functions as the first well 44 and the second well 46. In some embodiments, a single well 70 that functions as the first well 44 and the second well 46 is fluidically coupled to the pressure exchanger 210 and to the one or more pumps 234. In some embodiments, the pressure exchanger 210 and the one or more pumps 234 are coupled to a single well 70. In some embodiments, the pressure exchanger 210 and the one or more pumps 234 are coupled to a plurality of wells 70, each of which being configured to function as the first well 44 and the second well 46. In an example, each well 70 is coupled to the production manifold 150 and to the injection manifold 160.

The well 70 includes a production zone 72 and an injection zone 74. Fluids in the subterranean formation 42 flow into the well 70 at the production zone 72. Fluids flow from the well 70 into the subterranean formation 42 at the injection zone 74. The fracture network 60 in the subterranean formation 42 is fluidically coupled to the production zone 72 and to the injection zone 74.

In some embodiments, the well 70 is operated such that the fracture network 60 remains open while the geothermal fluid 102 is produced from the subterranean formation 42 into the production zone 72. In some embodiments, the well 70 is operated such that the fracture network 60 remains open while the geothermal fluid 102 is injected into the subterranean formation 42 at the injection zone 74. In an example, a pressure of the geothermal fluid 102 within the fracture network 60 is maintained at a magnitude that is greater than a closure pressure of one or more fractures of the fracture network 60. In another example, a pressure of the geothermal fluid 102 within the fracture network 60 is maintained at a magnitude that is greater than an opening pressure of one or more fractures of the fracture network 60. In another example, a pressure of the geothermal fluid 102 within the fracture network 60 is maintained at a magnitude that is between the opening pressure and the closure pressure of one or more fractures of the fracture network 60. In another example, a pressure of the geothermal fluid 102 within the fracture network 60 is maintained at a magnitude that is greater than a reopening pressure of one or more fractures of the fracture network 60. In another example, a pressure of the geothermal fluid 102 within the fracture network 60 is maintained at a magnitude that is between the reopening pressure and the closure pressure of one or more fractures of the fracture network 60.

In some embodiments, operation of the well 70 such that the fracture network 60 remains open is performed by regulating a pressure within the well 70 by a control valve, such as a choke. In some embodiments, operation of the well 70 such that fracture network 60 remains open is performed by regulating a pressure within the well 70 by controlling the operation of the pressure exchanger 210. In an example, the pressure drop experienced by the geothermal fluid 102 flowing through the pressure exchanger 210 creates a back-pressure on the geothermal fluid 102 exiting the well 70. In some embodiments, operation of a control valve is omitted when regulating a pressure within the well 70 by controlling the operation of the pressure exchanger 210. In some embodiments, operation of the well 70 such that the fracture network 60 remains open is performed by regulating the one or more pumps 234. In some embodiments, operation of the well 70 such that the fracture network 60 remains open is performed by regulating the one or more charge pumps 242.

The well 70 includes a tubing string 76 installed inside a casing string 78. A packer 82 seals an annulus 80 between the tubing string 76 and the casing string 78. The packer 82 is located between the production zone 72 and the injection zone 74. The geothermal fluid 102 in the subterranean formation 42 enters the well 70 at the production zone 72, and flows up the tubing string 76 to a wellhead 71. The geothermal fluid 102 flows from the wellhead 71 of the well 70 to the pressure exchanger 210. Operation of the pressure exchanger 210, the heat exchanger 26, and the one or more pumps 234 is as described above. The one or more pumps 234 inject the geothermal fluid 102 into the annulus 80 of the well 70. In some embodiments, the one or more charge pumps 242 inject additional geothermal fluid 102 from the reservoir 240 into the annulus 80 of the well 70. The geothermal fluid 102 exits the well 70 at the injection zone 74, and enters the subterranean formation 42.

The geothermal fluid 102 flows in the subterranean formation 42 from the injection zone 74 of the well 70 through the fracture network 60 towards the production zone 72 of the well 70. The geothermal fluid 102 is heated by the subterranean formation 42. In some embodiments, the producing of the geothermal fluid 102 from the subterranean formation 42 via the well 70, and the injecting of the geothermal fluid 102 into the subterranean formation 42 at the well 70 are performed simultaneously.

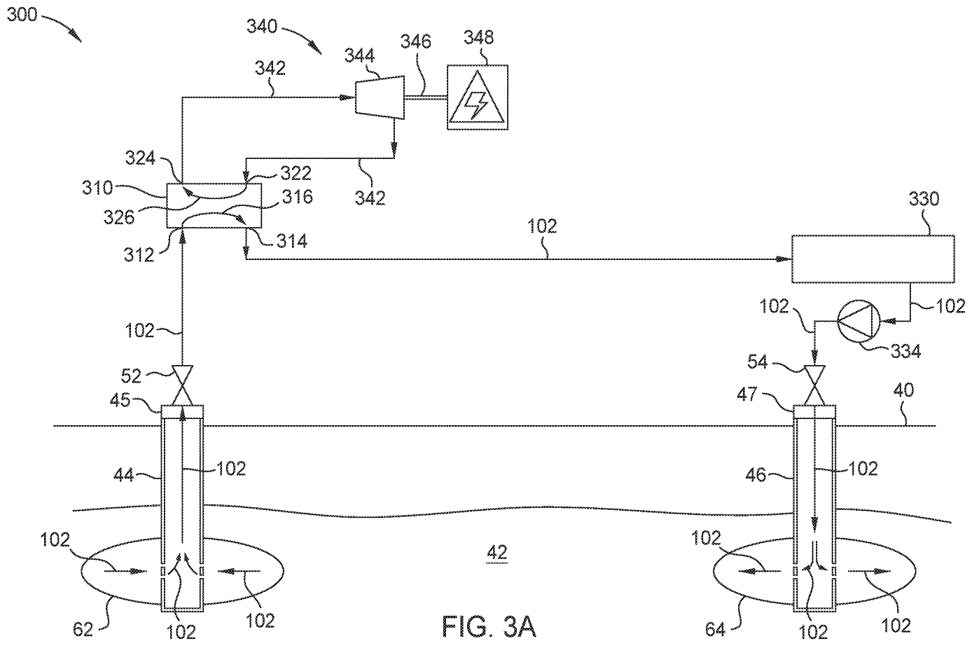

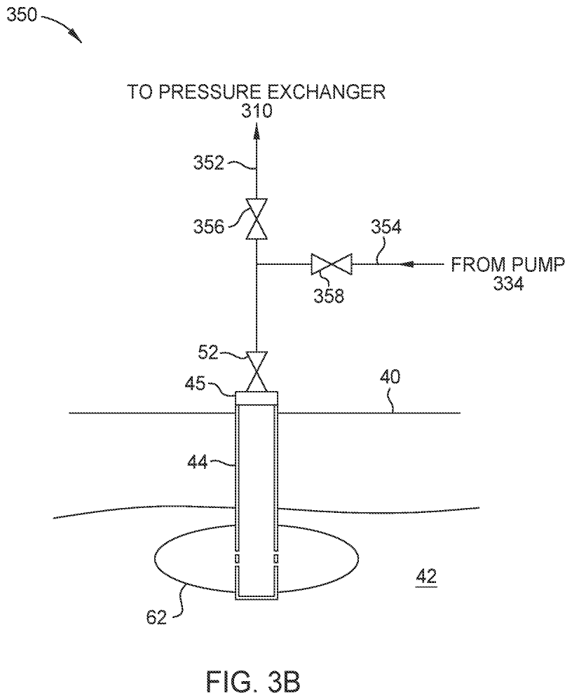

FIG. 3A schematically illustrates a geothermal power system 300. The geothermal power system 300 utilizes the geothermal fluid 102. The geothermal fluid 102 is heated, or is maintained at an elevated temperature, by the subterranean formation 42. In an example, the temperature of the geothermal fluid 102 is at or about 150 degrees C. or higher, such as 175 degrees C. or higher, 200 degrees C. or higher, 250 degrees C. or higher, or 300 degrees C. or higher. The geothermal fluid 102 is maintained at an elevated pressure in the subterranean formation 42. In an example, the pressure of the geothermal fluid 102 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the geothermal fluid 102 is geopressured. In an example, the geothermal fluid 102 may be a geopressured-geothermal fluid.

The geothermal fluid 102 flows from the subterranean formation 42 into the first well 44. In some embodiments, the geothermal fluid 102 flows from the subterranean formation 42 into the first well 44 via the one or more fractures 62 in the subterranean formation 42 at the first well 44. In some embodiments, the temperature of the geothermal fluid 102 at the wellhead 45 of the first well 44 is at or near the temperature of the geothermal fluid 102 in the subterranean formation 42.

The geothermal fluid 102 flows from the first well 44 to a pressure exchanger 310. In some embodiments, the geothermal power system 300 includes a plurality of pressure exchangers 310, such as in a parallel hookup configuration. In some embodiments, pressure exchanger 310 is similar to pressure exchanger 210. The geothermal fluid 102 flows into the pressure exchanger 310 at a first inlet 312, and exits the pressure exchanger 310 at a first outlet 314. The pressure of the geothermal fluid 102 is reduced as the geothermal fluid 102 transits through the pressure exchanger 310 from the first inlet 312 to the first outlet 314 along a first fluid path 316. In an example, the pressure of the geothermal fluid 102 at the first outlet 314 is at or about 20 MPa or less, such as 15 MPa or less, 10 MPa or less, 5 MPa or less, 3 MPa or less, 1 MPa or less, 0.5 MPa or less, or 0.2 MPa or less. The temperature of the geothermal fluid 102 at the first inlet 312 is at or near the temperature of the geothermal fluid 102 at the wellhead 45 of the first well 44. The temperature of the geothermal fluid 102 at the first outlet 314 is at or near the temperature of the geothermal fluid 102 at the first inlet 312.

The pressure exchanger 310 forms part of a power fluid circuit 340 that utilizes a power fluid (represented by arrows 342), such as water, steam, brine, a refrigerant, a supercritical fluid, carbon dioxide, ammonia, an organic compound (e.g., a hydrocarbon, a fluorocarbon, etc.), or any combination thereof. In some embodiments, the power fluid 342 is free, or substantially free, of suspended solids. In an example, the power fluid 342 has a suspended solids content of 0.5% by volume or less, such as 0.1% by volume or less, 0.05% by volume or less, 0.01% by volume or less, 0.005% by volume or less, or 0.001% by volume or less. The power fluid 342 flows into the pressure exchanger 310 at a second inlet 322, and exits the pressure exchanger 310 at a second outlet 324. The pressure exchanger 310 utilizes the pressure of the geothermal fluid 102 at the first inlet 312 to increase the pressure of the power fluid 342. The pressure of the power fluid 342 is increased as the power fluid 342 transits through the pressure exchanger 310 from the second inlet 322 to the second outlet 324 along a second fluid path 326. The second fluid path 326 is separate from the first fluid path 316. In an example, the pressure of the power fluid 342 at the second outlet 324 is at or about 3 MPa or higher, such as 5 MPa or higher, 10 MPa or higher, 20 MPa or higher, 30 MPa or higher, 40 MPa or higher, or 50 MPa or higher. In some embodiments, the pressure of the power fluid 342 at the second outlet 324 is less than the pressure of the geothermal fluid 102 at the first inlet 312.

The power fluid 342 flows from the pressure exchanger 310 to one or more turbines 344. In some embodiments, the one or more turbines 344 are Pelton Turbines. In some embodiments, the one or more turbines 344 are other types of turbine, such as Francis Turbines or Kaplan Turbines. In some embodiments, the one or more turbines 344 are located at the earth's surface 40. In some embodiments, the one or more turbines 344 are arranged in a series configuration such that the power fluid 342 flows to a first turbine 344 and then to a second turbine 344. In some embodiments, the one or more turbines 344 are arranged in a parallel configuration. In an example, a first portion of the power fluid 342 flows to a first turbine 344, and a different second portion of the power fluid 342 flows simultaneously to a second turbine 344. In another example, one of the first or second turbines 344 is offline (such as for maintenance), and the power fluid 342 flows to the other of the first or second turbines 344.

Each of the one or more turbines 344 is coupled to a corresponding shaft 346. Each shaft 346 is coupled to a corresponding generator 348. In an example, each shaft 346 is coupled to the corresponding generator 348 via a gearbox. Each turbine 344 drives the corresponding shaft 346, which drives the corresponding generator 348 to produce electricity.

In some embodiments, the power fluid 342 enters each turbine 344 at a temperature that is substantially equal to the temperature of the power fluid 342 at the second outlet 324 of the second pressure exchanger 310. In an example, the temperature of the power fluid 342 at each turbine 344 is within 10 degrees C., such as within 7 degrees C., within 5 degrees C., or within 2 degrees C., of the temperature of the power fluid 342 at the second outlet 324 of the second pressure exchanger 310. In some embodiments, the power fluid 342 does not flow through a heat exchanger between the second outlet 324 of the second pressure exchanger 310 and the one or more turbines 344.

The power fluid 342 flows through each turbine 344, and experiences a drop in pressure as the power fluid 342 drives each turbine 344 to rotate the corresponding shaft 346, and drive the corresponding generator 348 to produce electricity. In an example, the pressure of the power fluid 342 exiting each turbine 344 is at or about 1 MPa or less, such as 0.5 MPa or less, 0.4 MPa or less, 0.3 MPa or less, or 0.2 MPa or less. The power fluid 342 flows from each of the one or more turbines 344 back to the second inlet 322 of the pressure exchanger 310.

In some embodiments, the power fluid 342 enters the second inlet 322 of the pressure exchanger 310 at a temperature that is substantially equal to the temperature of the power fluid 342 exiting each of the one or more turbines 344. In an example, the temperature of the power fluid 342 at the second inlet 322 of the pressure exchanger 310 is within 10 degrees C., such as within 7 degrees C., within 5 degrees C., or within 2 degrees C., of the temperature of the power fluid 342 exiting each of the one or more turbines 344. In some embodiments, the power fluid 342 does not flow through a heat exchanger between each of the one or more turbines 344 and the second inlet 322 of the pressure exchanger 310. In some embodiments, the power fluid 342 exits the second outlet 324 of the pressure exchanger 310 at a temperature that is substantially equal to the temperature of the power fluid 342 at the second inlet 322 of the pressure exchanger 310.

The geothermal fluid 102 flows from the first outlet 314 of the pressure exchanger 310 to one or more pumps 334. Exemplary pumps 334 include single phase pumps, multi-phase pumps, centrifugal pumps, positive displacement pumps, or the like. The one or more pumps 334 increase a pressure of the geothermal fluid 102, and inject the geothermal fluid 102 into the second well 46. In some embodiments, the geothermal fluid 102 flows from the first outlet 314 of the pressure exchanger 310 to a reservoir 330 (such as a pond, a tank, or a subterranean formation different from subterranean formation 42), before flowing to the one or more pumps 334. In some embodiments, the reservoir 330 is omitted.

In some embodiments, the pressure of the geothermal fluid 102 at the wellhead 45 of the first well 44 is maintained at a magnitude such that the one or more fractures 62 remain open while the one or more pumps 334 pump the geothermal fluid 102 into the second well 46. In an example, the flow of the geothermal fluid 102 out of the first well 44 is choked by the valve 52. In another example, the pressure exchanger 310 is operated such that a back-pressure is exerted on the geothermal fluid at the wellhead 45 of the first well 44.

In some embodiments, the pressure of the geothermal fluid 102 at the wellhead 47 of the second well 46 is maintained at a magnitude such that the one or more fractures 64 remain open. In an example, the one or more pumps 334 are operated to maintain the pressure of the geothermal fluid 102 at the wellhead 47 of the second well 46 at a magnitude such that the one or more fractures 64 remain open.

In some embodiments, the one or more fractures 62 intersect with the one or more fractures 64. In some embodiments, the one or more fractures 62 are contiguous with the one or more fractures 64. In some embodiments, the geothermal fluid 102 flows within the subterranean formation 42 from the second well 46 to the first well 44, and is produced again from the first well 44.

As illustrated, in some embodiments, the geothermal fluid 102 does not flow within the subterranean formation 42 from the second well 46 to the first well 44. In an example, the one or more fractures 62 do not intersect with the one or more fractures 64. In another example, the one or more fractures 62 are not contiguous with the one or more fractures 64. In such embodiments, the geothermal power system 300 is reconfigured to flow the geothermal fluid 102 from the second well 46 to the pressure exchanger 310, and to flow the returning geothermal fluid 102 from the one or more pumps 334 to the first well 44. In an example, the geothermal power system 300 includes the manifold assembly 140, described above. When the geothermal power system 300 includes the manifold assembly 140, line 152 fluidically couples the production manifold 150 with the pressure exchanger 310. The manifold assembly 140, first well 44, second well 46, third well (if present), and fourth well (if present) are operated as described above.

Additionally, or alternatively, the geothermal power system 300 is coupled to the well 70, as described above. In such embodiments, the well 70 is operated as described above when coupled to the geothermal power system 300.

Additionally, or alternatively, the first well 44 is coupled to the geothermal power system 300 via a flowline assembly 350. FIG. 3B schematically illustrates an example flowline assembly 350 that facilitates flowing the geothermal fluid 102 from the first well 44 to the pressure exchanger 310, as described above, then pumping the geothermal fluid 102 back into the first well 44.

Line 352 conveys the geothermal fluid 102 from the first well 44 to the pressure exchanger 310. Line 354 conveys the geothermal fluid 102 from the one or more pumps 334 to the first well 44. When geothermal fluid 102 is flowing from the first well 44 to the pressure exchanger 310, valve 356 in line 352 is open, and valve 358 in line 354 is closed. When geothermal fluid 102 is flowing from the one or more pumps 334 to the first well 44, valve 358 in line 354 is open, and valve 356 in line 352 is closed.

In some embodiments, the first well 44 and the geothermal power system 300 are operated in a repeating alternating sequence of production of the geothermal fluid 102 from the subterranean formation 42, then reinjection of the geothermal fluid 102 into the subterranean formation 42. Such a sequence may be referred to as “huff and puff.” In such embodiments, the geothermal fluid 102 is produced from the subterranean formation 42 via the first well 44, and utilized (as described above) in the geothermal power system 300. The geothermal fluid 102 is then stored in the reservoir 330. Then the flow of the geothermal fluid 102 from the first well 44 is ceased. Valve 356 of the flowline assembly 350 is closed, and valve 358 of the flowline assembly 350 is opened. Then the one or more pumps 334 pump the geothermal fluid 102 from the reservoir 330 back into the first well 44, and inject the geothermal fluid 102 into the subterranean formation 42. Valve 358 of the flowline assembly 350 is closed, and valve 356 of the flowline assembly 350 is opened. Then the sequence is repeated. In some embodiments, a time delay is implemented while the first well 44 is closed-in to allow the geothermal fluid 102 in the subterranean formation 42 (such as in the one or more fractures 62) to become heated by the subterranean formation 42 before reopening the first well 44.

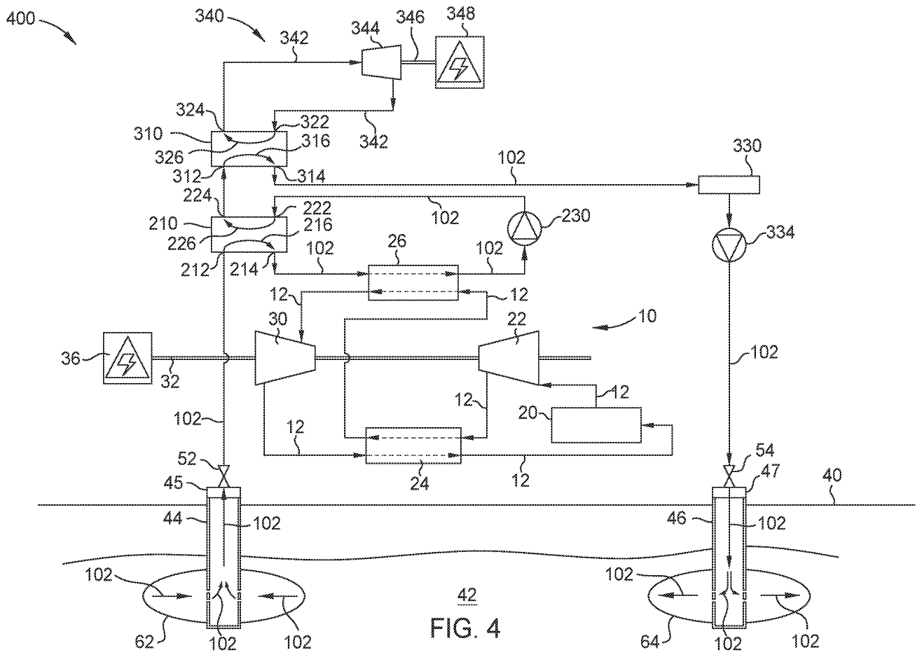

FIG. 4 schematically illustrates a geothermal power system 400. The geothermal power system 400 utilizes the geothermal fluid 102. The geothermal fluid 102 is heated, or is maintained at an elevated temperature, by the subterranean formation 42. In an example, the temperature of the geothermal fluid 102 is at or about 150 degrees C. or higher, such as 175 degrees C. or higher, 200 degrees C. or higher, 250 degrees C. or higher, or 300 degrees C. or higher. The geothermal fluid 102 is maintained at an elevated pressure in the subterranean formation 42. In an example, the pressure of the geothermal fluid 102 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the geothermal fluid 102 is geopressured. In an example, the geothermal fluid 102 may be a geopressured-geothermal fluid.

The geothermal power system 400 includes a combination of at least a portion of geothermal power system 200 and at least a portion of geothermal power system 300. The geothermal fluid 102 flows from the subterranean formation 42 into the first well 44, as described above. In some embodiments, the temperature of the geothermal fluid 102 at the wellhead 45 of the first well 44 is at or near the temperature of the geothermal fluid 102 in the subterranean formation 42.

The geothermal fluid 102 flows from the first well 44 to the pressure exchanger 210. The geothermal fluid 102 flows into the pressure exchanger 210 at the first inlet 212, and exits the pressure exchanger 210 at the first outlet 214. The pressure of the geothermal fluid 102 is reduced as the geothermal fluid 102 transits through the pressure exchanger 210 from the first inlet 212 to the first outlet 214 along the first fluid path 216. In an example, the pressure of the geothermal fluid 102 at the first outlet 214 is at or about 20 MPa or less, such as 15 MPa or less, 10 MPa or less, 5 MPa or less, 3 MPa or less, 1 MPa or less, 0.5 MPa or less, or 0.2 MPa or less. The temperature of the geothermal fluid 102 at the first inlet 212 is at or near the temperature of the geothermal fluid 102 at the wellhead 45 of the first well 44. The temperature of the geothermal fluid 102 at the first outlet 214 is at or near the temperature of the geothermal fluid 102 at the first inlet 212.

The geothermal fluid 102 flows from the first outlet 214 of the pressure exchanger 210 to the heat exchanger 26. In some embodiments, the temperature of the geothermal fluid 102 entering the heat exchanger 26 is similar to the temperature of the geothermal fluid 102 at the first well 44. In an example, the geothermal fluid 102 is at or about 150 degrees C. or higher, such as 175 degrees C. or higher, 200 degrees C. or higher, 250 degrees C. or higher, or 300 degrees C. or higher when entering the heat exchanger. Heat is transferred from the geothermal fluid 102 to the working fluid 12 as the geothermal fluid 102 flows through the heat exchanger 26. The temperature of the geothermal fluid 102 is lowered to a reduced level as the geothermal fluid 102 flows through the heat exchanger 26. In an example, the temperature of the geothermal fluid 102 upon exiting the heat exchanger 26 is at or about 100 degrees C. or less, such as 90 degrees C. or less, 80 degrees C. or less, 70 degrees C. or less, 60 degrees C. or less, or 50 degrees C. or less.

In some embodiments, the geothermal fluid 102 flows from the heat exchanger 26 to the one or more pumps 230. In some embodiments, the one or more pumps 230 are omitted. The geothermal fluid 102 flows from the heat exchanger 26 (via the one or more pumps 230, if present) to the pressure exchanger 210. The geothermal fluid 102 flows into the pressure exchanger 210 at the second inlet 222, and exits the pressure exchanger 210 at the second outlet 224. The pressure exchanger 210 utilizes the pressure of the relatively hotter geothermal fluid 102 at the first inlet 212 to increase the pressure of the relatively colder geothermal fluid 102 that enters the pressure exchanger 210 at the second inlet 222. The pressure of the geothermal fluid 102 is increased as the geothermal fluid 102 transits through the pressure exchanger 210 from the second inlet 222 to the second outlet 224 along the second fluid path 226. In an example, the pressure of the geothermal fluid 102 at the second outlet 224 is at or about 3 MPa or higher, such as 5 MPa or higher, 10 MPa or higher, 20 MPa or higher, 30 MPa or higher, 40 MPa or higher, or 50 MPa or higher. In some embodiments, the pressure of the geothermal fluid 102 at the second outlet 224 is less than the pressure of the geothermal fluid 102 at the first inlet 212. The temperature of the geothermal fluid 102 remains at or near the reduced level as the geothermal fluid 102 transits through the pressure exchanger 210 from the second inlet 222 to the second outlet 224 along the second fluid path 226.

The geothermal fluid 102 flows from the pressure exchanger 210 to the pressure exchanger 310. The geothermal fluid 102 flows into the pressure exchanger 310 at the first inlet 312, and exits the pressure exchanger 310 at the first outlet 314. The pressure of the geothermal fluid 102 is reduced as the geothermal fluid 102 transits through the pressure exchanger 310 from the first inlet 312 to the first outlet 314 along the first fluid path 316. In an example, the pressure of the geothermal fluid 102 at the first outlet 314 is at or about 1 MPa or less, such as 0.5 MPa or less, 0.4 MPa or less, 0.3 MPa or less, or 0.2 MPa or less. The temperature of the geothermal fluid 102 at the first inlet 312 is at or near the temperature of the geothermal fluid 102 at the second outlet 224 of the pressure exchanger 210. The temperature of the geothermal fluid 102 at the first outlet 314 of the pressure exchanger 310 is at or near the temperature of the geothermal fluid 102 at the first inlet 312 of the pressure exchanger 310.

The pressure exchanger 310 forms part of the power fluid circuit 340, as described above. The power fluid 342 of the power fluid circuit 340 flows into the pressure exchanger 310 at the second inlet 322, and exits the pressure exchanger 310 at the second outlet 324. The pressure exchanger 310 utilizes the pressure of the geothermal fluid 102 at the first inlet 312 to increase the pressure of the power fluid 342. The pressure of the power fluid 342 is increased as the power fluid 342 transits through the pressure exchanger 310 from the second inlet 322 to the second outlet 324 along the second fluid path 326. In an example, the pressure of the power fluid 342 at the second outlet 324 is at or about 3 MPa or higher, such as 5 MPa or higher, 10 MPa or higher, 20 MPa or higher, 30 MPa or higher, 40 MPa or higher, or 50 MPa or higher. In some embodiments, the pressure of the power fluid 342 at the second outlet 324 is less than the pressure of the geothermal fluid 102 at the first inlet 312.

The power fluid 342 flows from the pressure exchanger 310 to the one or more turbines 344. In some embodiments, the one or more turbines 344 are located at the earth's surface 40. In some embodiments, the one or more turbines 344 are arranged in a series configuration such that the power fluid 342 flows to a first turbine 344 and then to a second turbine 344. In some embodiments, the one or more turbines 344 are arranged in a parallel configuration. In an example, a first portion of the power fluid 342 flows to a first turbine 344, and a different second portion of the power fluid 342 flows simultaneously to a second turbine 344. In another example, one of the first or second turbines 344 is offline (such as for maintenance), and the power fluid 342 flows to the other of the first or second turbines 344.

In some embodiments, the power fluid 342 enters each turbine 344 at a temperature that is substantially equal to the temperature of the power fluid 342 at the second outlet 324 of the second pressure exchanger 310. In an example, the temperature of the power fluid 342 at each turbine 344 is within 10 degrees C., such as within 7 degrees C., within 5 degrees C., or within 2 degrees C., of the temperature of the power fluid 342 at the second outlet 324 of the second pressure exchanger 310. In some embodiments, the power fluid 342 does not flow through a heat exchanger between the second outlet 324 of the second pressure exchanger 310 and the one or more turbines 344.

Each turbine 344 drives the corresponding shaft 346, which drives the corresponding generator 348 to produce electricity, as described above. The power fluid 342 experiences a drop in pressure as the power fluid 342 drives each turbine 344 to rotate the corresponding shaft 346, and drive the corresponding generator 348 to produce electricity. In an example, the pressure of the power fluid 342 exiting each turbine 344 is at or about 1 MPa or less, such as 0.5 MPa or less, 0.4 MPa or less, 0.3 MPa or less, or 0.2 MPa or less. The power fluid 342 flows from each of the one or more turbines 344 to the second inlet 322 of the pressure exchanger 310.

In some embodiments, the power fluid 342 enters the second inlet 322 of the pressure exchanger 310 at a temperature that is substantially equal to the temperature of the power fluid 342 exiting each of the one or more turbines 344. In an example, the temperature of the power fluid 342 at the second inlet 322 of the pressure exchanger 310 is within 10 degrees C., such as within 7 degrees C., within 5 degrees C., or within 2 degrees C., of the temperature of the power fluid 342 exiting each of the one or more turbines 344. In some embodiments, the power fluid 342 does not flow through a heat exchanger between each of the one or more turbines 344 and the second inlet 322 of the pressure exchanger 310.

The geothermal fluid 102 flows from the first outlet 314 of the pressure exchanger 310 to the one or more pumps 334. The one or more pumps 334 increase a pressure of the geothermal fluid 102, and inject the geothermal fluid 102 into the second well 46. In some embodiments, the geothermal fluid 102 flows from the first outlet 314 of the pressure exchanger 310 to the reservoir 330 before flowing to the one or more pumps 334.

In some embodiments, the pressure of the geothermal fluid 102 at the wellhead 45 of the first well 44 is maintained at a magnitude such that the one or more fractures 62 remain open while the one or more pumps 334 pump the geothermal fluid 102 into the second well 46. In an example, the flow of the geothermal fluid 102 out of the first well 44 is choked by the valve 52. In another example, the pressure exchanger 210 is operated such that a back-pressure is exerted on the geothermal fluid 102 at the wellhead 45 of the first well 44.

In some embodiments, the pressure of the geothermal fluid 102 at the wellhead 47 of the second well 46 is maintained at a magnitude such that the one or more fractures 64 remain open. In an example, the one or more pumps 334 are operated to maintain the pressure of the geothermal fluid 102 at the wellhead 47 of the second well 46 at a magnitude such that the one or more fractures 64 remain open.

In some embodiments, the one or more fractures 62 intersect with the one or more fractures 64. In some embodiments, the one or more fractures 62 are contiguous with the one or more fractures 64. In some embodiments, the geothermal fluid 102 flows within the subterranean formation 42 from the second well 46 to the first well 44, and is produced again from the first well 44.

As illustrated, in some embodiments, the geothermal fluid 102 does not flow within the subterranean formation 42 from the second well 46 to the first well 44. In an example, the one or more fractures 62 do not intersect with the one or more fractures 64. In another example, the one or more fractures 62 are not contiguous with the one or more fractures 64. In such embodiments, the geothermal power system 400 is reconfigured to flow the geothermal fluid 102 from the second well 46 to the pressure exchanger 210, and to flow the returning geothermal fluid 102 from the one or more pumps 334 to the first well 44. In an example, the geothermal power system 400 includes the manifold assembly 140, described above. When the geothermal power system 400 includes the manifold assembly 140, line 152 fluidically couples the production manifold 150 with the pressure exchanger 210. The manifold assembly 140, first well 44, second well 46, third well (if present), and fourth well (if present) are operated as described above.

Additionally, or alternatively, the geothermal power system 400 is coupled to the well 70, as described above. In such embodiments, the well 70 is operated as described above when coupled to the geothermal power system 300.

Additionally, or alternatively, the first well 44 is coupled to the geothermal power system 400 via the flowline assembly 350, described above. In such embodiments, the first well 44 is operated as described above when coupled to the geothermal power system 400 via the flowline assembly 350.

In some embodiments, the first well 44 and the geothermal power system 400 are operated in a repeating alternating sequence of production of the geothermal fluid 102 from the subterranean formation 42, then reinjection of the geothermal fluid 102 into the subterranean formation 42. In such embodiments, the geothermal fluid 102 is produced from the subterranean formation 42 via the first well 44, and utilized (as described above) in the geothermal power system 400. The geothermal fluid 102 is then stored in the reservoir 330. Then the flow of the geothermal fluid 102 from the first well 44 is ceased. Valve 356 of the flowline assembly 350 is closed, and valve 358 of the flowline assembly 350 is opened. Then the one or more pumps 334 pump the geothermal fluid 102 from the reservoir 330 back into the first well 44, and inject the geothermal fluid 102 into the subterranean formation 42. Valve 358 of the flowline assembly 350 is closed, and valve 356 of the flowline assembly 350 is opened. Then the sequence is repeated. In some embodiments, a time delay is implemented while the first well 44 is closed-in to allow the geothermal fluid 102 in the subterranean formation 42 (such as in the one or more fractures 62) to become heated by the subterranean formation 42 before reopening the first well 44.

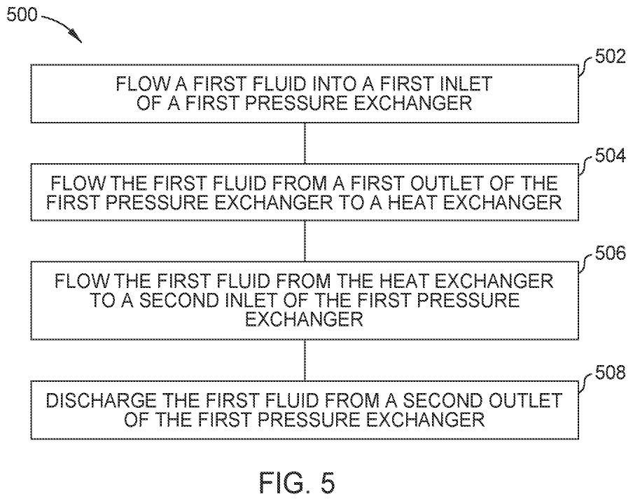

FIG. 5 is a flow diagram of a method 500 of operating a geothermal power system. The geothermal power system may be any of geothermal power system 200 or 400.

Operation 502 includes flowing a first fluid into a first inlet of a first pressure exchanger. In some embodiments, the first fluid is a geothermal fluid, such as geothermal fluid 102. In some embodiments, the first fluid is produced from a subterranean formation, such as subterranean formation 42. In some embodiments, the first pressure exchanger is pressure exchanger 210.

Operation 504 includes flowing the first fluid from a first outlet of the first pressure exchanger to a heat exchanger. In some embodiments, method 500 includes reducing a pressure of the first fluid in the first pressure exchanger as the first fluid transits from the first inlet to the first outlet. In some embodiments, the heat exchanger is heat exchanger 26. In some embodiments, method 500 includes using heat of the first fluid to increase a temperature of a second fluid at the heat exchanger. In some embodiments, the second fluid is a working fluid, such as working fluid 12. In some embodiments, method 500 includes flowing the second fluid through an expander coupled to a generator, and generating electricity using the generator.

Operation 506 includes flowing the first fluid from the heat exchanger to a second inlet of the first pressure exchanger. In some embodiments, operation 406 includes pumping the first fluid from the heat exchanger to a second inlet of the first pressure exchanger.

Operation 508 includes discharging the first fluid from a second outlet of the first pressure exchanger. In some embodiments, operation 508 includes increasing a pressure of the first fluid in the first pressure exchanger as the first fluid transits from the second inlet to the second outlet.

In some embodiments, the first fluid transits from the first inlet of the first pressure exchanger to the first outlet of the first pressure exchanger in a first fluid path, and transits from the second inlet of the first pressure exchanger to the second outlet of the first pressure exchanger in a second fluid path separate from the first fluid path.

In some embodiments, method 500 includes flowing the first fluid into a first inlet of a second pressure exchanger (such as pressure exchanger 310). In some embodiments, flowing the first fluid into a first inlet of a second pressure exchanger occurs after discharging the first fluid from a second outlet of the first pressure exchanger. In some embodiments, method 500 includes reducing a pressure of the first fluid in the second pressure exchanger as the first fluid transits from the first inlet of the second pressure exchanger to a first outlet of the second pressure exchanger. In some embodiments, method 500 includes increasing a pressure of a second fluid in the second pressure exchanger as the second fluid transits from a second inlet of the second pressure exchanger to a second outlet of the second pressure exchanger. In some embodiments, the second fluid is a power fluid, such as power fluid 342. In some embodiments, method 500 includes flowing the second fluid through a turbine coupled to a generator, and generating electricity using the generator.

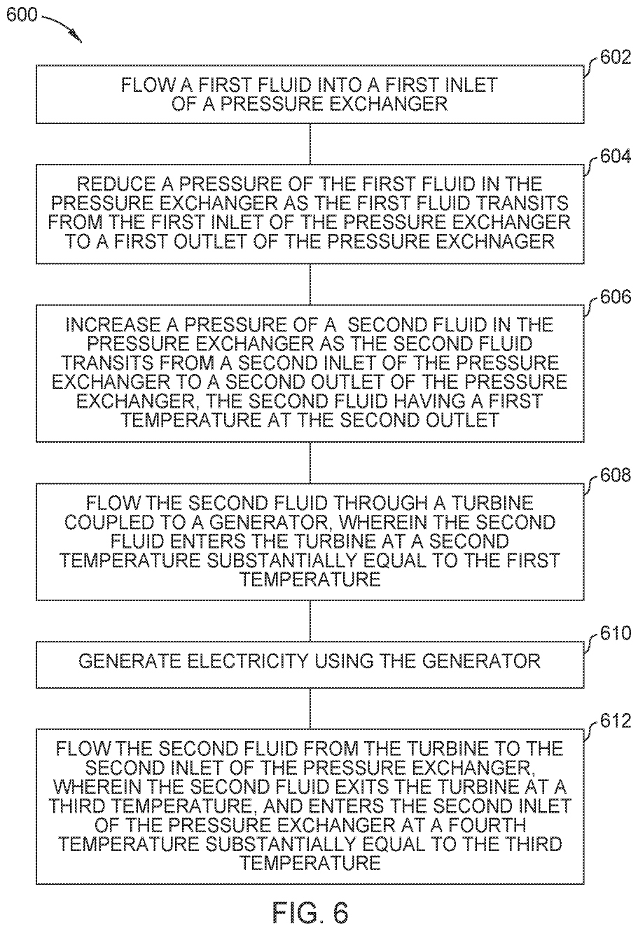

FIG. 6 is a flow diagram of a method 600 of operating a geothermal power system. The geothermal power system may be any of geothermal power system 300 or 400.

Operation 602 includes flowing a first fluid into a first inlet of a pressure exchanger. In some embodiments, the first fluid is a geothermal fluid, such as geothermal fluid 102. In some embodiments, the first fluid is produced from a subterranean formation, such as subterranean formation 42. In some embodiments, the pressure exchanger is pressure exchanger 310.

Operation 604 includes reducing a pressure of the first fluid in the pressure exchanger as the first fluid transits from the first inlet of the pressure exchanger to a first outlet of the pressure exchanger.

Operation 606 includes increasing a pressure of a second fluid in the pressure exchanger as the second fluid transits from a second inlet of the pressure exchanger to a second outlet of the pressure exchanger, the second fluid having a first temperature at the second outlet. In some embodiments, the second fluid is a power fluid, such as power fluid 342. In some embodiments, the first fluid transits from the first inlet of the pressure exchanger to the first outlet of the pressure exchanger in a first fluid path, and the second fluid transits from the second inlet of the pressure exchanger to the second outlet of the pressure exchanger in a second fluid path separate from the first fluid path.

Operation 608 includes flowing the second fluid through a turbine (such as one of the one or more turbines 344) coupled to a generator. In some embodiments, the second fluid enters the turbine at a second temperature substantially equal to the first temperature. In an example, the second temperature is within 10 degrees C., such as within 7 degrees C., within 5 degrees C., or within 2 degrees C., of the first temperature. In some embodiments, the second fluid does not flow through a heat exchanger between the second outlet of the pressure exchanger and the turbine.

Operation 610 includes generating electricity using the generator.

Operation 612 includes flowing the second fluid from the turbine to the second inlet of the pressure exchanger. In some embodiments, the second fluid exits the turbine at a third temperature, and enters the second inlet of the pressure exchanger at a fourth temperature substantially equal to the third temperature. In an example, the second temperature is within 10 degrees C., such as within 7 degrees C., within 5 degrees C., or within 2 degrees C., of the third temperature. In some embodiments, the second fluid does not flow through a heat exchanger between the turbine and the second inlet of the pressure exchanger.

In some embodiments, method 600 includes producing the first fluid from a subterranean formation into a well, and flowing the first fluid from the well to the pressure exchanger. In some embodiments, method 600 includes pumping the first fluid into the well, and injecting the first fluid back into the subterranean formation. In some embodiments, method 600 includes flowing the first fluid from the pressure exchanger to a reservoir (such as reservoir 330) prior to pumping the first fluid into the well. In some embodiments, method 600 includes ceasing production of the first fluid from the well prior to pumping the first fluid into the well. In some embodiments, producing the first fluid from the subterranean formation comprises producing the first fluid from the subterranean formation at a first zone of the well, and injecting the first fluid back into the subterranean formation comprises injecting the first fluid into the subterranean formation at a second zone of the well, the second zone different from the first zone.

In some embodiments, method 600 includes producing the first fluid from a subterranean formation into a first well (such as first well 44), flowing the first fluid from the first well to the pressure exchanger, and injecting the first fluid back into the subterranean formation via a second well (such as second well 46). In some embodiments, method 600 includes injecting additional geothermal fluid into the second well, the additional geothermal fluid being sourced from a reservoir (such as reservoir 240). In some embodiments, method 600 includes injecting the additional geothermal fluid into the second well using a charge pump (such as charge pump 242). In some embodiments, method 600 includes injecting the additional geothermal fluid into the second well using the charge pump to establish a selected operating pressure at a wellhead of the second well. The operating pressure at the wellhead of the second well may be selected such that one or more fractures in the subterranean formation coupled to the second well are open.

It is contemplated that method 500 may include any one or more of the operations or activities described herein. It is contemplated that method 600 may include any one or more of the operations or activities described herein.

Aspects of the present disclosure present systems and methods for generating electricity using a geothermal fluid. In some aspects, pressure energy of the geothermal fluid is converted into electricity. In some aspects, heat energy of the geothermal fluid is converted into electricity. In some aspects, a pressure of the geothermal fluid is reduced in a first flow path through a pressure exchanger, and then increased in a second flow path in the same pressure exchanger. Benefits of the systems and methods of the present disclosure include more effective use of geothermal resources compared to conventional geothermal power systems.

It is contemplated that any one or more elements or features of any one disclosed embodiment may be beneficially incorporated in any one or more other non-mutually exclusive embodiments. While the foregoing is directed to embodiments of the present disclosure, other and further embodiments of the disclosure may be devised without departing from the basic scope thereof, and the scope thereof is determined by the claims that follow.

What is claimed is:

1. A method of operating a geothermal power system, comprising:
flowing a first fluid into a first inlet of a first pressure exchanger;
flowing the first fluid from a first outlet of the first pressure exchanger to a heat exchanger;
flowing the first fluid from the heat exchanger to a second inlet of the first pressure exchanger; and
discharging the first fluid from a second outlet of the first pressure exchanger.

2. The method of claim 1, further comprising increasing a pressure of the first fluid in the first pressure exchanger as the first fluid transits from the second inlet to the second outlet.

3. The method of claim 1, further comprising reducing a pressure of the first fluid in the first pressure exchanger as the first fluid transits from the first inlet to the first outlet.

4. The method of claim 1, further comprising using heat of the first fluid to increase a temperature of a second fluid at the heat exchanger.

5. The method of claim 4, further comprising:
flowing the second fluid through an expander coupled to a generator; and
generating electricity using the generator.

6. The method of claim 1, further comprising:
flowing the first fluid into a first inlet of a second pressure exchanger;
reducing a pressure of the first fluid in the second pressure exchanger as the first fluid transits from the first inlet of the second pressure exchanger to a first outlet of the second pressure exchanger; and
increasing a pressure of a second fluid in the second pressure exchanger as the second fluid transits from a second inlet of the second pressure exchanger to a second outlet of the second pressure exchanger.

7. The method of claim 6, further comprising:
flowing the second fluid through a turbine coupled to a generator; and
generating electricity using the generator.

8. A method of operating a geothermal power system, comprising:
flowing a first fluid into a first inlet of a pressure exchanger;
reducing a pressure of the first fluid in the pressure exchanger as the first fluid transits from the first inlet of the pressure exchanger to a first outlet of the pressure exchanger;
increasing a pressure of a second fluid in the pressure exchanger as the second fluid transits from a second inlet of the pressure exchanger to a second outlet of the pressure exchanger, the second fluid having a first temperature at the second outlet;
flowing the second fluid through a turbine coupled to a generator, wherein the second fluid enters the turbine at a second temperature substantially equal to the first temperature;
generating electricity using the generator; and
flowing the second fluid from the turbine to the second inlet of the pressure exchanger, wherein the second fluid exits the turbine at a third temperature, and enters the second inlet of the pressure exchanger at a fourth temperature substantially equal to the third temperature.

9. The method of claim 8, further comprising producing the first fluid from a subterranean formation into a well, and flowing the first fluid from the well to the pressure exchanger.

10. The method of claim 9, further comprising pumping the first fluid into the well, and injecting the first fluid back into the subterranean formation.

11. The method of claim 10, further comprising flowing the first fluid from the pressure exchanger to a reservoir prior to pumping the first fluid into the well.

12. The method of claim 10, further comprising ceasing production of the first fluid from the well prior to pumping the first fluid into the well.

13. The method of claim 10, wherein:
producing the first fluid from the subterranean formation comprises producing the first fluid from the subterranean formation at a first zone of the well; and
injecting the first fluid back into the subterranean formation comprises injecting the first fluid into the subterranean formation at a second zone of the well, the second zone different from the first zone.

14. A geothermal power system, comprising:
a heat exchanger fluidically coupled to a first pressure exchanger, wherein:
a first fluid enters the first pressure exchanger at a first inlet, and transits through the first pressure exchanger in a first fluid path from the first inlet to a first outlet;
the heat exchanger receives the first fluid from the first outlet of the first pressure exchanger;
the first pressure exchanger receives the first fluid from the heat exchanger at a second inlet of the pressure exchanger; and
the first fluid transits through the first pressure exchanger in a second fluid path from the second inlet to a second outlet, the second fluid path separate from the first fluid path.

15. The geothermal power system of claim 14, further comprising a binary cycle power plant configured to operate with a second fluid, the binary cycle power plant including:
the heat exchanger;
an expander fluidically coupled to the heat exchanger; and
a generator coupled to the expander.

16. The geothermal power system of claim 14, further comprising a second pressure exchanger, wherein a first inlet of the second pressure exchanger is fluidically coupled to the second outlet of the first pressure exchanger.

17. The geothermal power system of claim 16, wherein the first fluid transits through the second pressure exchanger in a third fluid path from the first inlet of the second pressure exchanger to a first outlet of the second pressure exchanger.

18. The geothermal power system of claim 17, further comprising a fluid circuit, the fluid circuit including:
the second pressure exchanger;
a turbine fluidically coupled to the second pressure exchanger; and
a generator coupled to the turbine.

19. The geothermal power system of claim 18, wherein the turbine is fluidically coupled to the second pressure exchanger at a second inlet of the second pressure exchanger and at a second outlet of the second pressure exchanger.

20. The geothermal power system of claim 19, wherein a third fluid transits through the second pressure exchanger in a fourth fluid path from the second inlet of the second pressure exchanger to the second outlet of the second pressure exchanger, the fourth fluid path separate from the third fluid path.
